(19) United States
(12) Patent Application Publication
(10) Pub. No.: US 2011/0083567 A1
(43) Pub. Date: Apr. 14, 2011

(54) Food Preparation Device

(76) Inventor: Ed Kramer, Baton Rouge, LA (US)

(21) Appl. No.: 12/825,869

(22) Filed: Jun. 29, 2010

Related U.S. Application Data
(60) Provisional application No. 61/251,734, filed on Oct. 14, 2009.

(51) Int. Cl. A47J 43/04

(52) U.S. Cl. 99/532

(57) ABSTRACT

An improved food preparation device for tenderizing and injecting marinade into a food product is contemplated. In one aspect, the device includes one or more needles having features for improved marinade dispersion. In another aspect, the device may include an adjustable guard configured to cause marinade to be injected when a bottom surface of the adjustable guard impacts a food surface. The amount of marinade injected is related to the distance the adjustable guard or plunger travels thereby providing even marinade distribution through the food being prepared. The configuration also provides a variable marinade flow rate related to a force applied to the device or the speed at which the device is operated. The adjustable guard may be vertically adjustable relative to an outlet end of the needles to allow the depth of penetration of the needles to be precisely controlled prior to initiation of marinade injection.

### RELATED APPLICATIONS

This application claims the benefit of U.S. Provisional Patent Application Ser. No. 61/251,734 titled Food Preparation Device filed on Oct. 14, 2009 by the inventor of the present application, the contents of which are incorporated herein by reference.

### FIELD OF THE INVENTION

The present invention relates generally to food preparation devices and particularly to a device for tenderizing a food product while simultaneously injecting a marinade.

### BACKGROUND OF THE INVENTION

A number of solutions currently exist for tenderizing and marinading food products such as meat. Existing solutions include devices that allow food products to be tenderized by way of needles or prongs while simultaneously injecting marinade. However, such devices suffer various drawbacks related to marinade dispersion, flow-rate control, complexity and cleanliness. Improvements to existing food preparation devices are thus desired.

### SUMMARY OF THE INVENTION

Applicant has recognized several deficiencies in existing food preparation devices capable of both tenderizing and marinading meat. Existing food preparation devices suffer various drawbacks related to marinade dispersion, flow-rate control, complexity and cleanliness. An improved food preparation device for simultaneously tenderizing and injecting marinade into a food product is thus contemplated.

In one aspect, the exemplary food preparation device may include one or more hollow prongs or needles each having a pointed end for piercing a food product. The needles may each have an enlarged outlet end and may include side-facing outlet openings for providing improved marinade dispersion into the food product. Each needle is in fluid communication with a fluid reservoir where a marinade is stored. In another exemplary aspect, the device may also include an adjustable guard configured such that providing downward pressure on the device causes marinade to be injected into the food product when a bottom surface of the adjustable guard impacts the food surface. This has the benefit of evenly distributing marinade through the meat without causing unwanted marinade leakage. The configuration further provides a variable marinade flow rate, the flow rate being related to the amount of force applied to the device or the speed at which the device is operated. The amount of marinade that is dispensed is also proportionally related to the distance which the adjustable guard or plunger travels relative to the housing thereby allowing the marinade to be distributed evenly through the food being prepared regardless of the speed or force with which the device is operated. In another aspect, the adjustable guard may be vertically adjustable relative to the outlet end of the needles to allow the depth of penetration of the needles to be precisely controlled. This has the additional benefit of allowing a measured and predictable amount of marinade to be injected with each stroke. In another exemplary aspect, the food preparation device may be configured with a spring-loaded plunger for allowing the marinade and tenderizing action to be repeated efficiently and without operator intervention. An improved food preparation device is thus contemplated that overcomes the limitations of existing devices.

### BRIEF DESCRIPTION OF THE DRAWINGS

FIG. 1A is a perspective view of a food preparation device in accordance with an exemplary embodiment of the invention.

FIG. 1B is another perspective view of the exemplary food preparation device of FIG. 1A.

FIG. 2A is another perspective view of the exemplary food preparation device of FIG. 1A.

FIG. 2B is another perspective view of the exemplary food preparation device of FIG. 1A.

FIG. 3 is a side view of the exemplary food preparation device of FIG. 1A.

FIG. 4 is an exploded view of the exemplary food preparation device of FIG. 1A.

FIG. 5A is a perspective view of a needle assembly in accordance with the exemplary food preparation device of FIG. 1A.

FIG. 5B is another perspective view of the needle assembly of FIG. 5A.

FIG. 6A is a perspective view of a main body housing in accordance with the exemplary food preparation device of FIG. 1A.

FIG. 6B is another perspective view of the main body housing of FIG. 6A.

FIG. 6C is another perspective view of the main body housing of FIG. 6A.

FIG. 6D is another perspective view of the main body housing of FIG. 6A.

FIG. 7 is a perspective view of an adjustable guard in accordance with the exemplary food preparation device of FIG. 1A.

FIG. 8 is a perspective view of a plunger in accordance with the exemplary food preparation device of FIG. 1A.

FIG. 9 is a perspective view of a housing cap in accordance with the exemplary food preparation device of FIG. 1A.

FIG. 10 is a section view of the exemplary food preparation device of FIG. 1A configured in a ready state.

FIG. 11 is another section view of the exemplary food preparation device of FIG. 1A configured in a plunged state.

FIG. 12 is a perspective view of a needle assembly in accordance with another exemplary embodiment of the invention.

### DETAILED DESCRIPTION

Reference will now be made in detail to the present exemplary embodiments of the invention, examples of which are illustrated in the accompanying drawings.

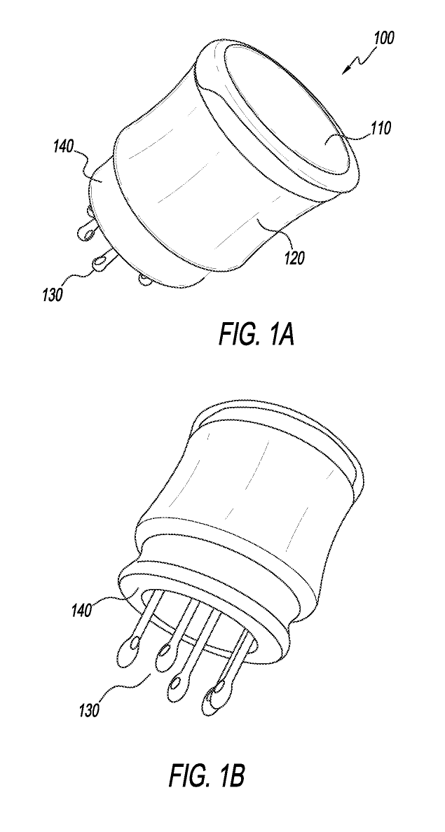

Referring now to FIG. 1A and FIG. 1B, diagrams are shown that illustrate perspective views of a food preparation device 100 in accordance with an exemplary embodiment of the invention. As shown, the food preparation device 100 includes a main body housing 120, a housing cap 110, a needle assembly 130 and an adjustable guard 140. The food preparation device is shown in a ready state, with the needle assembly 130 extending partially below a bottom surface of the adjustable guard 140. The food preparation device is configured in the ready state just prior to use.

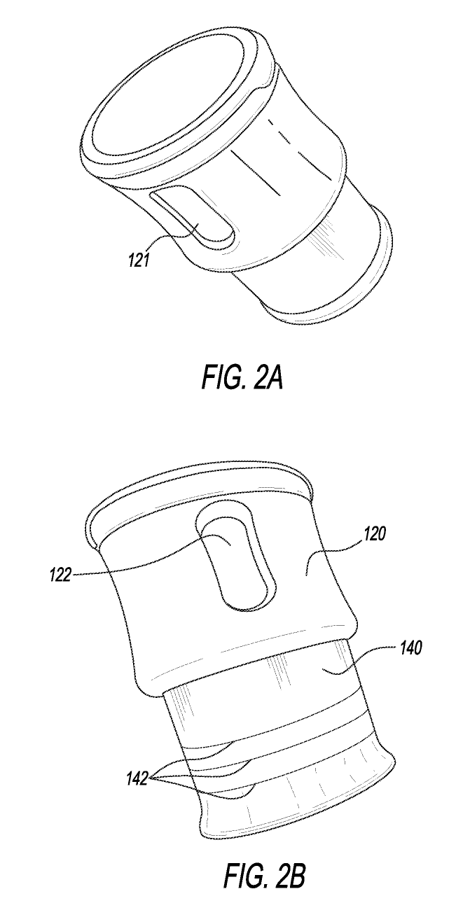

Referring now to FIG. 2A and FIG. 2B, diagrams are shown that illustrate perspective views of the food preparation device 100 of FIG. 1A configured in a closed state. As shown in FIG. 2A and FIG. 2B, the bottom surface of the adjustable guard 140 is positioned below the needle assembly 130. The food preparation device 100 is considered to be in the closed state when the adjustable guard 140 is positioned as shown in FIG. 2A and FIG. 2B. The food preparation device 100 is configured in the closed state when the device is not in use. In this manner the positioning of the adjustable guard 140 mitigates the risk of contact with the needle assembly 130. The main body housing 120 may also include a window 122 for providing a means for viewing the internal contents of the food preparation device 100. The adjustable guard 140 may also include indicia 142 for assisting the user with accurately positioning the adjustable guard 140 for different types of food.

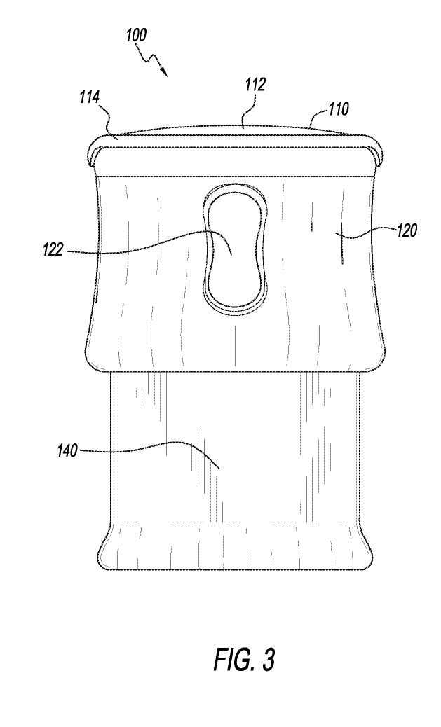

Referring now to FIG. 3, a diagram is shown illustrating a side view of the exemplary food preparation device 100 configured in the closed state. By way of example only, the food preparation device 100 may have an overall outer diameter of approximately 2.5 inches and a height of approximately 3.875 inches.

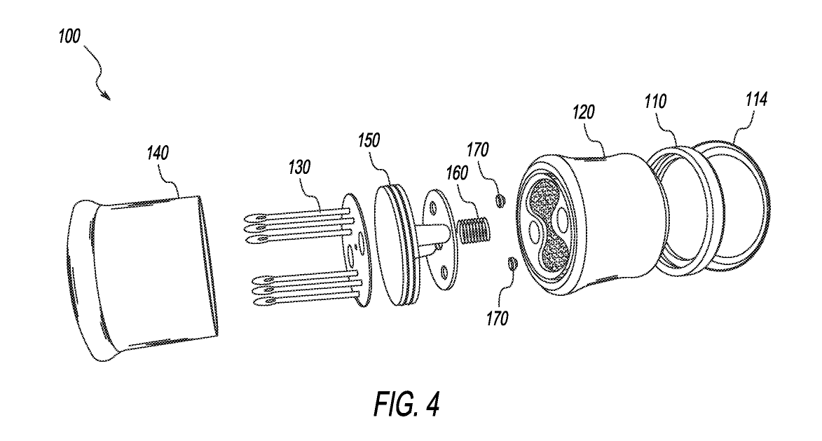

Referring now to FIG. 4, a diagram is shown illustrating an exploded view of the exemplary food preparation device 100 of FIG. 1A. As shown the food preparation device 100 also includes a plunger 150, a spring 160, and one or more valves labeled generally as 170. The food preparation device 100 also includes a housing cap 110 (having an optional a trim element 114) that is configured to be removably attachable to the main body housing 120. Each of the components of the food preparation device 100 will now be discussed in greater detail.

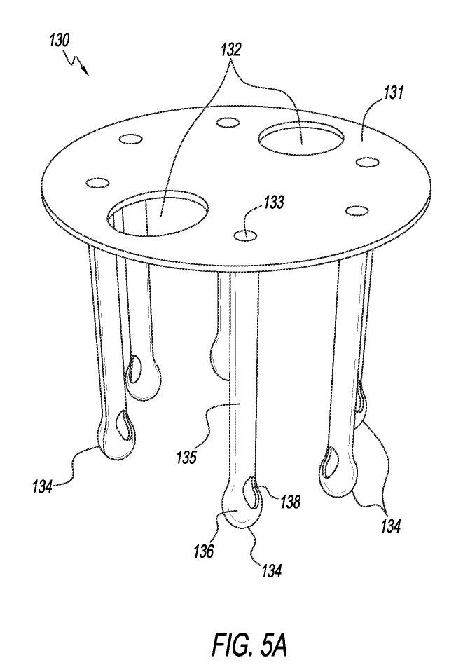

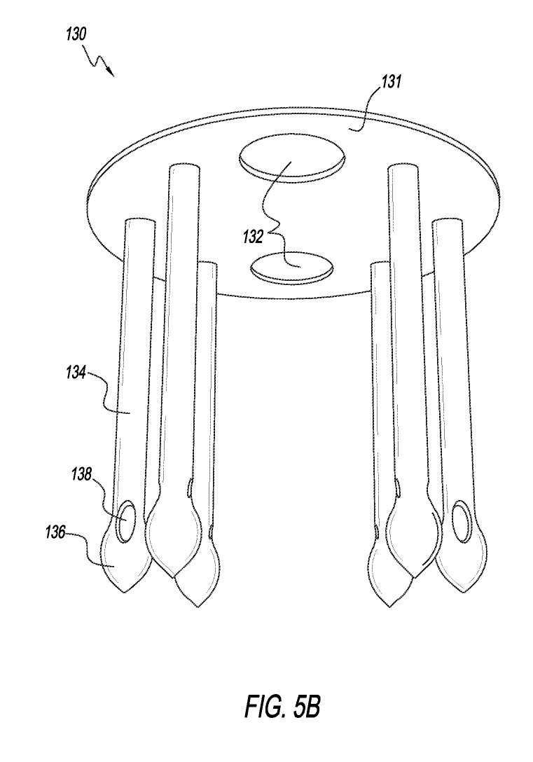

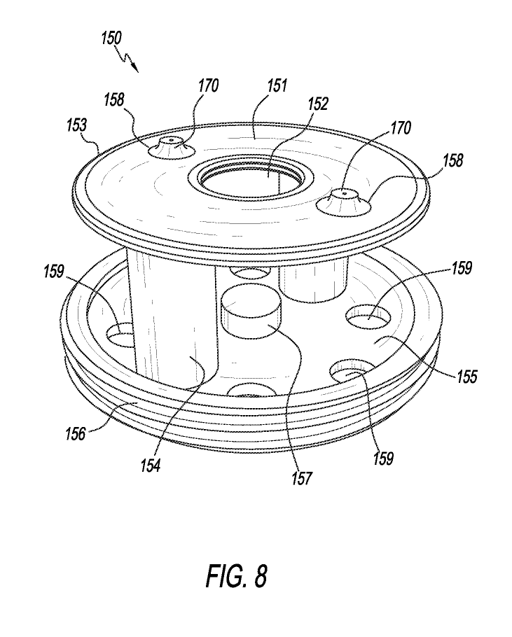

Referring now to FIG. 5A and FIG. 5B, diagrams are shown illustrating perspective views of a needle assembly 130 in accordance with the exemplary food preparation device of FIG. 1A. As shown, the needle assembly 130 includes a plurality of needles or prongs, each labeled generally as 134 and a base plate 131. The base plate 131 includes two plunger holes 132 sized to receive plunger columns 154 (shown in FIG. 8). The base plate 131 also includes a plurality of needle holes labeled generally as 133. Each needle hole 133 is sized to mate with an inlet end of one of the needles 134. It is noted that while six needles 134 are shown, more or fewer needles may be employed. Each needle 134 includes an elongated hollow body 135 having an inlet end sized to mate with one of the needle holes 133 and an outlet end 136 adapted to penetrate the surface of a food product such as meat. By way of example, the inlet end of the needle 134 may be fixedly attached to the base plate 131 by welding or similar attachment means. The outlet end 136 may be a hollowed tip having a maximum outer diameter larger than an outer diameter of the elongated hollow body 135. By way of example, the outlet end 136 may have a bulbous shape. Each outlet end 136 may also include one or more outlet holes, labeled generally as 138. The outlet holes 138 may be positioned on a side of the outlet end 136 of the needle 134, thus pointing in a direction substantially perpendicular to a longitudinal axis of the food preparation device 100. Positioning the outlet holes 138 on the sides of the needles 134 advantageously allows marinade to be dispersed more evenly throughout the food being prepared. The outlet holes 138 may also be positioned relative to one another in such a way as to further improve marinade dispersion. By way of example, the outlet holes 138 of a first half of the needles 134 may be positioned substantially orthogonal to the outlet holes 138 of the remaining half of needles 134. Other such patterns may be used depending on the desired marinade dispersion. The base plate 131 may have an outer diameter of approximately 1.875 inches. The needles 134 may have an overall length of approximately 1.627 inches. The needle assembly 130 may be comprised of a metal such as stainless steel.

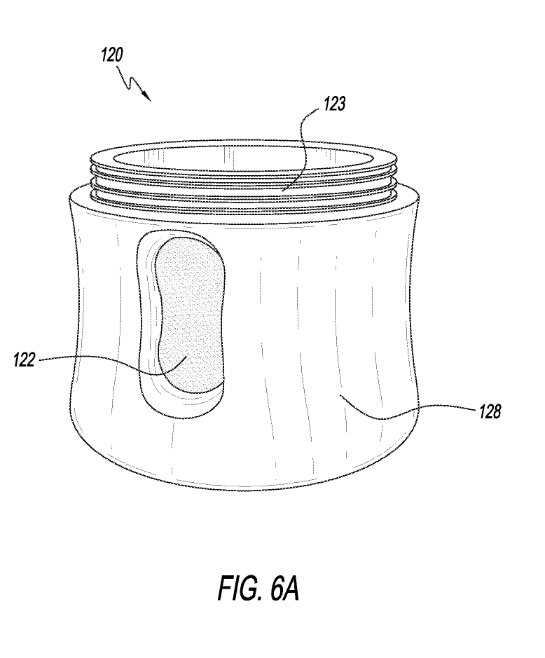

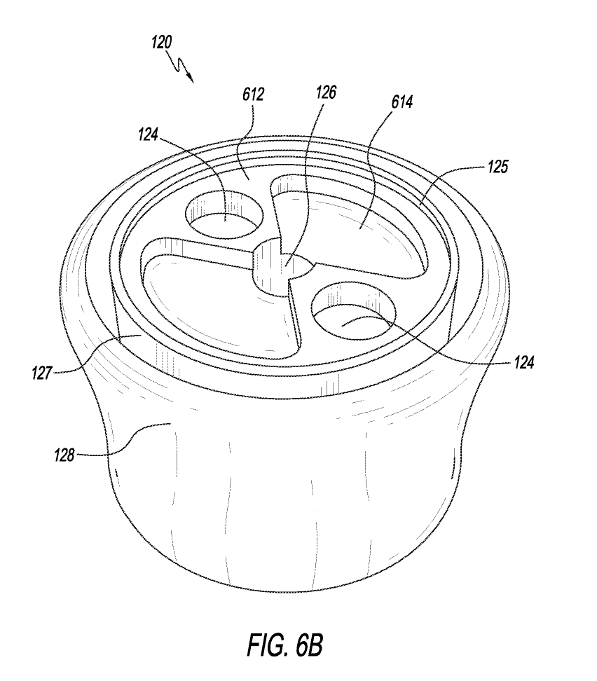

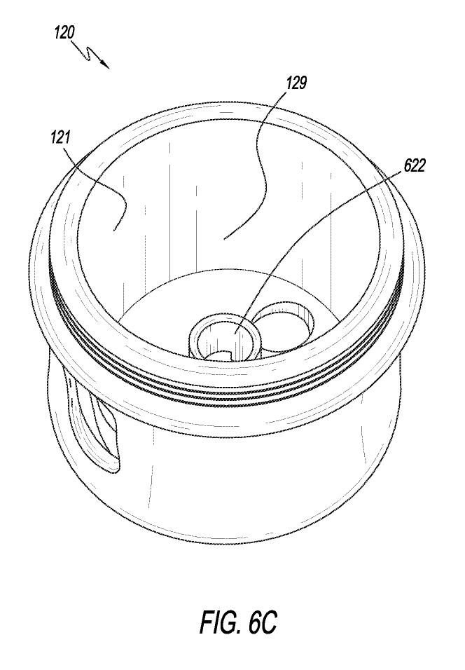

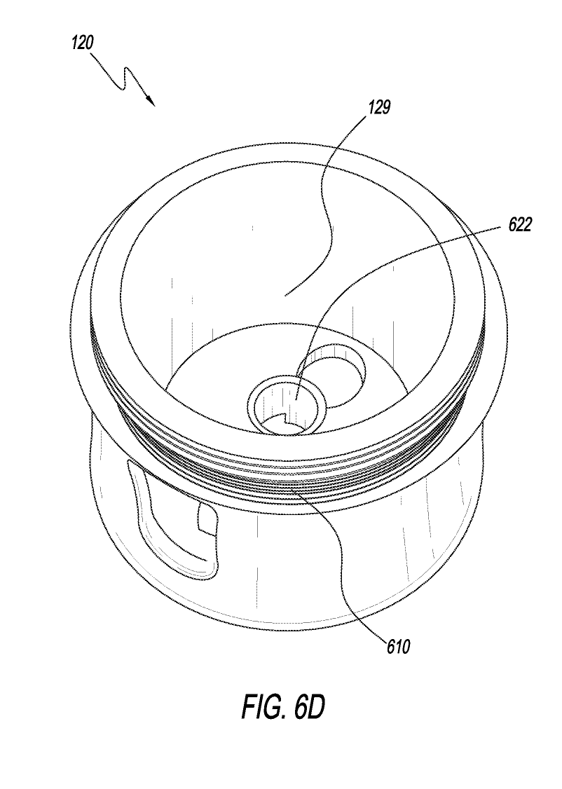

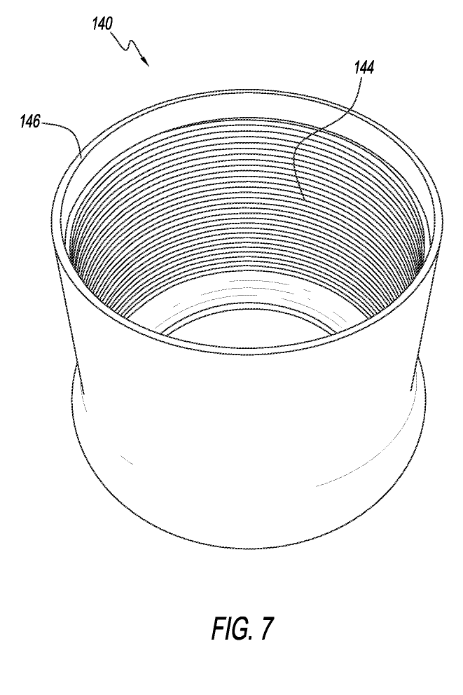

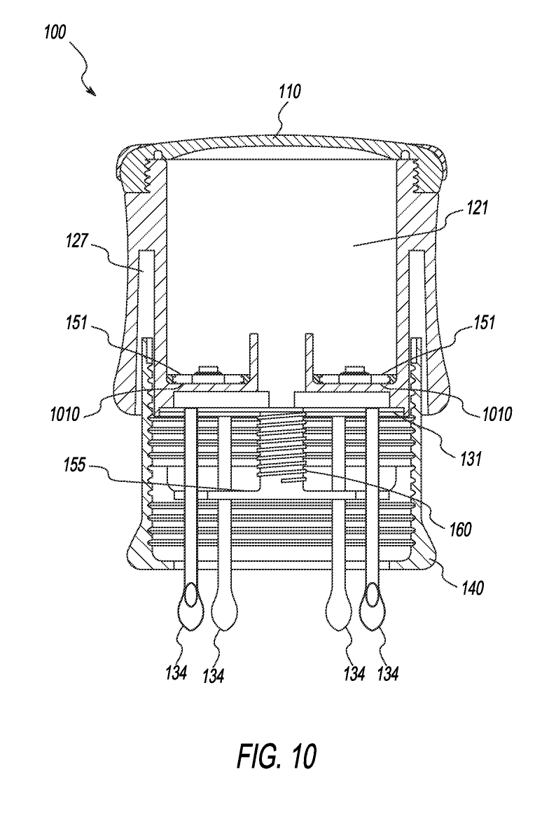

Referring now to FIG. 6A-6D, diagrams are shown illustrating perspective views of a main body housing 120 in accordance with the exemplary food preparation device 100 of FIG. 1A. The main body housing 120 is substantially cylindrical in shape and has a hollow core 121, suitable for acting as a fluid reservoir that stores fluid such as a food marinade. The main body housing 120 has an outer surface labeled as 128 and an inner surface labeled as 129. The main body housing 120 is substantially open at a first end and is adapted to be removably coupled to the cap 110 (shown in FIG. 1A). By way of example the top end of the main body housing 120 may include a threaded portion 123 to provide a means for coupling the main body housing 120 to the cap 110. A rubber gasket 610 may also be disposed around the circumference of the top end of the main body housing 120 to prevent fluid leakage. The housing 120 also includes a channel 127 located between the outer surface 128 and the inner surface 129. The channel 127 extends from a bottom end of the main body housing 120 (see FIG. 10) and is thus openly accessible from the bottom end of the housing. The channel 127 is sufficiently wide to receive a top section of the adjustable guard 140 (shown in FIG. 1A) and sufficiently deep to allow the needle assembly 130 to penetrate the food being prepared. By way of example, the channel 127 may be approximately 0.1 to 0.135 inches wide and approximately 1.25 inches deep. The main body housing 120 also includes a bottom section 125 having two holes, labeled generally as 124, that extend from the bottom end of the housing 120 through to the hollow core 121. The holes 124 are sized to receive plunger columns 154 (shown in FIG. 8). The bottom section 125 also has a bottom surface 612 sized to mate with a top surface of the base plate 131 of the needle assembly 130. The base plate 131 may be fixedly attached to bottom surface 612 by way of a quarter turn lock. The bottom surface 612 also includes a cutout section 614 shaped to allow the needle holes on the base plate 131 to remain in fluid communication with the hollow core 121. The bottom section 125 also has a center channel 126 that also extends from the bottom surface 612 of the housing 120 through to the hollow core 121. The center channel 126 also includes a cylindrical protrusion 622 that extends from the bottom section of the housing 120 and partially into the hollow core 121. The center channel 126 allows liquid stored in the hollow core 121 to travel into the cutout section 614 of the main body housing 120 and into the needles 134 in a controlled manner. As discussed, the main body housing 120 may also include window 122 for allowing the internal contents of the food preparation device 100 to be viewed externally. The main body housing 120 may have an outer diameter of approximately 2.5 inches, a thickness of approximately 0.375 inches and an overall length of approximately 2 inches. The main body housing 120 may be comprised of plastic.

Referring now to FIG. 7 a diagram is shown illustrating a perspective view of the adjustable guard 140 in accordance with the exemplary food preparation device 100 of FIG. 1A. As shown, the adjustable guard 140 is substantially cylindrical in shape and has a hollow core. The adjustable guard 140 also has a threaded inner surface 144 configured to engage a threaded outer surface of the plunger 150 (shown in FIG. 8). The adjustable guard 140 is sized to allow a top section 146 to slidably move within the channel 127 of the main body housing 120. The adjustable guard 140 may have an outer diameter of approximately 2.125 inches, a thickness of approximately 0.125 inches an overall length of approximately 1.75 inches. The adjustable guard 140 may be comprised of plastic.

Referring now to FIG. 8, a diagram is shown illustrating a perspective view of a plunger 150 in accordance with the exemplary food preparation device 100 of FIG. 1A. As shown, the plunger 150 includes a cylindrical upper plate 151, a cylindrical lower plate 155 and two plunger columns 154 coupled between the upper plate 151 and the lower plate 155. The upper plate 151 has an outer diameter sized to slidably fit within the inner surface 129 of the main body housing 120. A rubber seal 153 may also be disposed around the outer circumference of the upper plate 151 to prevent fluid leakage. The upper plate 151 also includes a circular cutout 152 disposed at the center of the upper plate 151. The circular cutout 152 is sized to allow the cylindrical protrusion 622 that extends from the bottom section of the main body housing 120 to slidably fit within the circular cutout 152. A rubber seal may also be disposed around the circular cutout 152 to prevent fluid leakage. The upper plate 151 also includes one or more valve cutouts, labeled generally as 158. The valve cutouts 158 are sized to hold one of the valves 170 which, which by way of example may be check valves. An O-ring may also be disposed between the valve 170 and the valve cutout 158. The plunger columns 154 may be fixedly attached to the upper plate and removably attached to the lower plate 155 by two screws or similar fasteners. The lower plate 155 is substantially cylindrical in shape and has a threaded outer surface 156 configured to engage the inner surface 144 of the adjustable guard 140. The lower plate 155 also includes a plurality of holes 159 sized and positioned to receive the needles 134 of the needle assembly 130 (shown in FIG. 5A). The lower plate 155 also includes a cylindrical protrusion 157 that extends from a top surface of the lower plate 155 and partially into the space between the lower plate 155 and the upper plate 151. The cylindrical protrusion 157 is sized to allow the spring 160 to be slidably disposed around the protrusion 157. The cylindrical upper plate 151 may have an outer diameter of approximately 1.75 inches and a thickness of approximately 0.0625 inches. The cylindrical lower plate 155 may have an outer diameter of approximately 2 inches and a thickness of approximately 0.25 inches. The plunger 150 may have an overall height of approximately 0.938 inches. The plunger 150 may be comprised of plastic.

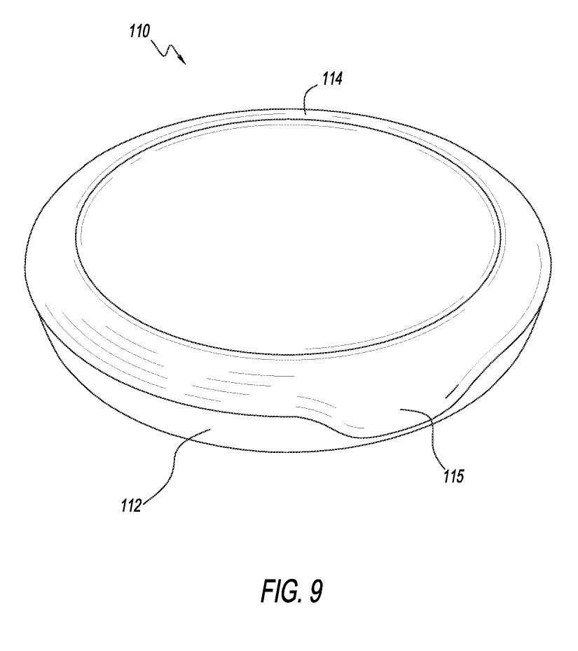

Referring now to FIG. 9, a diagram is shown illustrating a perspective view of a housing cap 110 in accordance with the exemplary food preparation device 100 of FIG. 1A. The housing cap 110 is substantially cylindrical in shape and has a lower section 112 adapted to be removably attachable to the threaded portion 123 of the main body housing 120. By way of example the lower section 112 may have a threaded inner surface. The housing cap 110 may also include a trim element 114 that includes a tab 115. The housing cap 110 may have an outer diameter of approximately 2.45 inches and a thickness of approximately 0.44 inches. The housing cap 110 may be comprised of plastic.

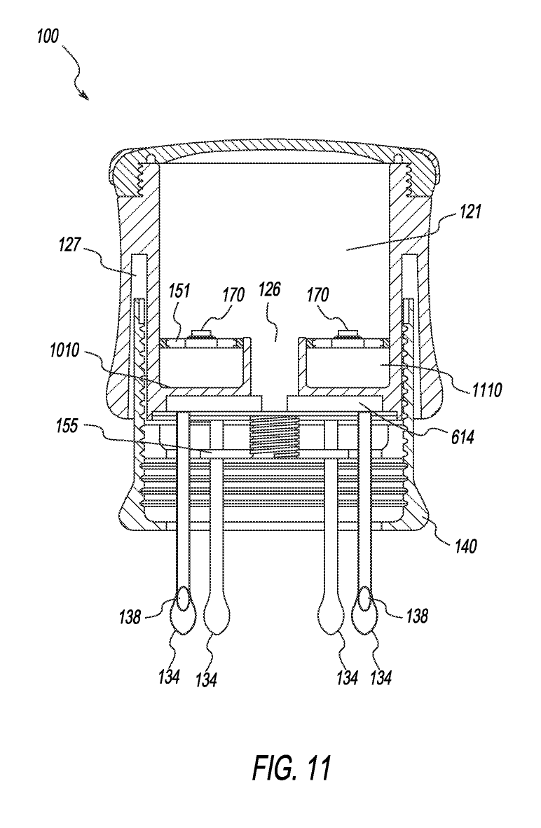

Referring now to FIG. 10, a diagram is shown illustrating a section view of the exemplary food preparation 100 device of FIG. 1A configured in a ready state. Prior to using the device 100 to marinade and tenderize a food product, the device is transitioned by a user from the closed state (shown in FIG. 2A) to the ready state shown in FIG. 10. In order to transition the device from the closed state to the ready state the user may rotate the adjustable guard 140 in a clockwise direction. This rotation causes the adjustable guard 140 to translate vertically upward relative to other elements of the device 100. The channel 127 of the main body housing allows the adjustable guard 140 to translate unimpeded. As the adjustable guard 140 moves upward, the distance between the bottom surface of the adjustable guard 140 and the bottom of the needle assembly 130 increases. The distance created between these components determines the depth of penetration of the needles 134 into the food being prepared. By way of example, the user may choose a larger distance for thicker foods such as chicken and a smaller distance for thinner foods such as steak. In addition to modifying the adjustable guard 140, the user may also add fluid such as a food marinade to the hollow inner core 121 of the main body housing 120. To add fluid to the main body housing 120 the user may remove the housing cap 110 (e.g. by rotating it in a counterclockwise direction) and pour a desired amount of fluid directly into the hollow inner core 121. By way of example, the hollow inner core 121 may be sized to store approximately 2.3 ounces of fluid. When in the ready state, the upper plate 151 of the plunger 150 is positioned substantially adjacent to a lower inner surface 1010 of the main body housing 120. As shown, the spring 160 is positioned between a lower surface of the base plate 131 of the needle assembly 130 and an upper surface of the cylindrical lower plate 155 of the plunger 150. The spring 160, thus provides a downward force on the plunger 150 thereby holding the upper plate 151 of the plunger 150 substantially adjacent to the lower inner surface 1010 of the main body housing 120. At this point the device 100 may be transitioned by a user from the ready state to the plunged state shown in FIG. 11.

Referring now to FIG. 11 a diagram is shown illustrating a section view of the exemplary food preparation device of FIG. 1A configured in a plunged state. The device 100 transitions from the ready state to the plunged state when the bottom surface of the adjustable guard 140 impacts the surface of the food being prepared. This advantageously occurs after the needles 134 penetrate the surface of the food, thereby providing better dispersion of marinade through the food. The adjustable guard 140 also creates an enclosure around the area of impact thus mitigating the chance of marinade spraying or otherwise escaping the surface of the food. Upon impacting the food surface the adjustable guard 140 generates an upward force on the plunger 150 of similar strength to a downward force applied by the user to a top surface of the device 100. When the resulting upward force is of sufficient strength to overcome the spring force, the plunger 150 moves in an upward direction relative to the main body housing 120. The cylindrical upper plate 151 thus separates from the lower inner surface 1010 of the main body housing 120 thereby displacing fluid stored in the inner core 121. Fluid is thus forced through center channel 126, into the cutout section 614 and then through the needles 134. The fluid then exits the needles through the needle outlet holes 138 and enters the food being prepared. By way of example, approximately 0.25 ounces of fluid may be forced through the needles 134 with each downward stroke. After the stroke is complete and pressure is removed from the top surface of the device 100, the spring force again acts to push the upper plate 151 of the plunger 150 against the lower inner surface 1010 of the main body housing 120. As the upper plate 151 returns to the ready position, a gap 1110 that was created during the downward stroke closes, forcing air that had collected in the gap 1110 through valves 170 and into the inner core 121. The plunger 150 may then displace a similar amount of fluid during each subsequent downward stroke. The amount of fluid displaced is thus proportional to the distance the plunger travels relative to the housing thereby for the fluid to be distributed evenly through the food being prepared regardless of the speed or force with which the device is operated. The preceding steps may be repeated until the fluid is substantially removed from the inner core 121. The device may be returned to the closed state by rotating the adjustable guard in a counterclockwise direction until the needles 134 are safely enclosed.

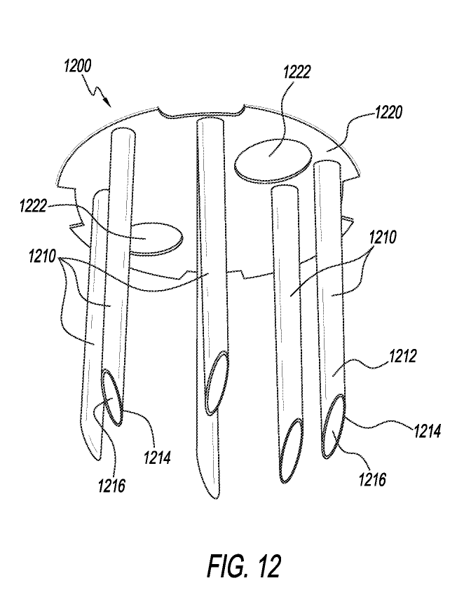

Referring now to FIG. 12, a diagram is shown illustrating a perspective view of a needle assembly 1200 in accordance with another exemplary embodiment of the invention. The needle assembly is configured in a similar manner as the needle assembly 130 of FIG. 5A and FIG. 5B. As shown, the needle assembly 1200 includes a plurality of needles or prongs, each labeled generally as 1210 and a base plate 1220. The base plate 1220 includes two plunger holes 1222 sized to receive plunger columns 154 (shown in FIG. 8). The base plate 1220 also includes a plurality of needle holes each sized to mate with an inlet end of one of the needles 1210. It is noted that while six needles 1210 are shown, more or fewer needles may be employed. Each needle 1210 includes an elongated hollow body 1212 having an inlet end sized to mate with one of the needle holes and an outlet end 1214 adapted to penetrate the surface of a food product such as meat. By way of example, the inlet end of each needle 1210 may be fixedly attached to the base plate 1220 by welding or similar attachment means. Each outlet end 1214 may be cut at an angle relative to a horizontal plane thereby forming at least one outlet hole, labeled generally as 1216, and a tip suitable for penetrating meat. The outlet holes 1216 may also be positioned relative to one another in such a way as to further improve marinade dispersion. By way of example, one or more of the outlet holes 1216 of the needles 1210 may be positioned to direct the marinade in a first direction while the outlet holes 1216 of the remaining needles 1210 may be positioned to direct the marinade in a second direction. The outlet holes 1216 may alternately be positioned such that each directs the marinade in an outward direction relative to a center of the device. Other such patterns may be used depending on the desired marinade dispersion. The base plate 1220 may have an outer diameter of approximately 1.875 inches. The needles 1210 may have an overall length of approximately 1.627 inches. The needle assembly 1200 may be comprised of a metal such as stainless steel.

Thus, an improved food preparation device is contemplated having the benefits of simultaneously tenderizing and marinading meat in a clean and safe manner. In one aspect, the device may include one or more needles having features for providing improved marinade dispersion. In another aspect, the device may include an adjustable guard configured to cause marinade to be injected when a bottom surface of the adjustable guard impacts a food surface. The adjustable guard may be vertically adjustable relative to an outlet end of the needles to allow the depth of penetration of the needles to be precisely controlled prior to initiation of marinade injection. The amount of marinade injected is related to the distance the adjustable guard or plunger travels relative to the housing thereby providing even marinade distribution through the food being prepared regardless of the speed or force with which the device is operated. In another aspect the device provides a variable marinade flow rate, the flow rate being related to the force or speed at which the device is operated. A spring-loaded plunger may also be provided for allowing the marinade and tenderizing action to be repeated efficiently and without operator intervention. An improved food preparation device is thus contemplated that overcomes the limitations of known food preparation devices.

While the foregoing invention has been described with reference to the above-described embodiments, various modifications and changes can be made without departing from the spirit of the invention. Accordingly, all such modifications and changes are considered to be within the scope of the appended claims.

1. A food preparation device comprising:
a cylindrical housing having a reservoir for storing a fluid, the cylindrical housing have an open top section;
a housing cap adapted to be removably attachable to the top section of the cylindrical housing;
a prong assembly coupled to a bottom section of the housing, the prong assembly including a plurality of hollow prongs each having an inlet end in fluid communication with said reservoir and an outlet end with at least one outlet hole; and
a plunging mechanism slidably coupled to said housing, the plunging mechanism having:
a cylindrical lower plate with a plurality of circular cutouts each sized to receive one of said hollow prongs;
a cylindrical upper plate having an outer diameter sized to slidably engage an inner surface of the cylindrical housing and an inner diameter sized to slidably engage the outer surface of a cylindrical protrusion that extends from the bottom section of the cylindrical housing; and
one or more columns disposed between the cylindrical upper plate and the cylindrical lower plate, the columns being sized to slidably fit within one or more holes disposed on the bottom section of the cylindrical housing;
wherein the cylindrical upper plate is adapted to force said fluid from said reservoir through each of said hollow prongs in response to a plunging force applied to the cylindrical lower plate, the plunging force being a force applied in a direction that is substantially opposite a direction of travel of the hollow prongs when entering a food surface.

2. The food preparation device of claim 1, further comprising a spring configured between the lower cylindrical plate and the bottom section of the cylindrical housing, the spring being positioned to oppose the plunging force.

3. The food preparation device of claim 2, wherein the cylindrical lower plate has a threaded outer surface and the food preparation device further comprises an adjustable guard being cylindrical in shape and having a threaded inner surface adapted to engage the threaded outer surface of the cylindrical lower plate,
wherein rotation of the adjustable guard causes the adjustable guard translate vertically relative to the cylindrical lower plate.

4. The food preparation device of claim 3, wherein the adjustable guard is sufficiently long to be translated between a closed position and a ready position, the bottom surface of the adjustable guard extending past the outlet end of each of the one or more hollow prongs in the closed position and being positioned above the outlet end of each of the plurality of hollow prongs in the ready position.

5. The food preparation device of claim 4, wherein the cylindrical housing has a channel located between an outer surface of the cylindrical housing and the inner surface of the cylindrical housing, the channel extending from the bottom section of the cylindrical housing and being sufficiently wide to receive a top section of the adjustable guard.

6. The food preparation device of claim 5, wherein the cylindrical upper plate further comprises one or more holes each sized to hold a valve for controlling air pressure.

7. The food preparation device of claim 1, wherein the outlet end of each hollowed prong is cut at an angle to form the outlet hole.

8. The food preparation device of claim 1, wherein each hollow prong includes an elongated body having an outer diameter smaller than an outer diameter of the outlet end of the hollow prong.

9. The food preparation device of claim 8, wherein the outlet end of each hollow prong is bulbous in shape.

10. The food preparation device of claim 9, wherein the outlet opening of each hollow prong is pointed in a direction that is substantially perpendicular to a longitudinal axis of the food preparation device.

11. The food preparation device of claim 9, wherein the outlet opening of at least one hollow prong is pointed in a direction that is substantially perpendicular to the outlet opening of another of said hollow prongs.

12. A food preparation device comprising:
a housing having a reservoir for storing a fluid;
one or more hollow prongs coupled to a bottom section of the housing, each of said hollow prongs having an inlet end in fluid communication with said reservoir and having an outlet end with at least one outlet hole; and
a plunging mechanism slidably coupled to said housing, the plunging mechanism adapted to force said fluid from said reservoir through each of said hollow prongs in response to a plunging force applied to the plunging mechanism, the plunging force being a force applied in a direction that is substantially opposite a direction of travel of the hollow prongs when entering a food surface.

13. The food preparation device of claim 12, further comprising a spring configured between the plunging mechanism and the housing, the spring being positioned to oppose the plunging force.

14. The food preparation device of claim 12, further comprising:
an adjustable body coupled to said plunging mechanism, the adjustable body being adapted to transmit the plunging force to said plunging mechanism in response to an external force applied to a bottom surface of the adjustable body.

15. The food preparation device of claim 14, wherein the adjustable body is coupled to the plunging mechanism in such a way that the body may be vertically translated relative to said plunging mechanism.

16. The food preparation device of claim 15, wherein the plunging mechanism has a cylindrical lower plate with a threaded outer surface, and the adjustable body is substantially cylindrical in shape and has a threaded inner surface, the threaded inner surface adapted to engage the threaded outer surface of the cylindrical lower plate.

17. The food preparation device of claim 15, wherein the adjustable body is sufficiently long to be translated between a closed position and a ready position, the bottom surface of the adjustable body being positioned to extend past the outlet end of each of the one or more hollow prongs in the closed position and above the outlet end of each of the one or more hollow prongs in the ready position.

18. The food preparation device of claim 17, wherein the housing has a channel located between an outer surface of the housing and an inner surface of the housing, the channel extending from the bottom section of the housing and being sufficiently wide to receive a top section of the adjustable body.

19. The food preparation device of claim 15, wherein the plunging mechanism further comprises:
a cylindrical lower plate with a plurality of circular cutouts each sized to receive one of said hollow prongs;
a cylindrical upper plate having an outer diameter sized to slidably engage an inner surface of the cylindrical housing and an inner diameter sized to slidably engage the outer surface of a cylindrical protrusion that extends from the bottom section of the cylindrical housing; and
one or more columns disposed between the cylindrical upper plate and the cylindrical lower plate, the columns being sized to slidably fit within one or more holes disposed on the bottom section of the cylindrical housing.

20. The food preparation device of claim 15, wherein the outlet end of each hollowed prong is cut at an angle to form the outlet hole.

21. The food preparation device of claim 15, wherein each hollow prong includes an elongated body having an outer diameter smaller than an outer diameter of the outlet end of the hollow prong.

22. The food preparation device of claim 21, wherein the outlet end of each hollow prong is bulbous in shape.

23. The food preparation device of claim 12, wherein the outlet opening of each hollow prong is pointed in a direction that is substantially perpendicular to a longitudinal axis of the food preparation device.

24. The food preparation device of claim 23, comprising a plurality of hollow prongs; and wherein the outlet opening of at least one hollow prong is pointed in a direction that is substantially perpendicular to the outlet opening of another of said hollow prongs.

25. The food preparation device of claim 15, wherein the plunging mechanism is configured such that the quantity of fluid that is forced through the one or more hollow prongs is proportional to a distance that the plunging mechanism travels.
